(19) United States
(12) Patent Application Publication
(10) Pub. No.: US 2018/0361992 A1
(43) Pub. Date: Dec. 20, 2018

(54) VEHICLE LIGHTING SYSTEM

(71) Applicant: Yazaki Corporation, Tokyo (JP)

(72) Inventor: Hiroyasu TAKAGI, Makinohara-shi (JP)

(73) Assignee: Yazaki Corporation, Tokyo (JP)

(21) Appl. No.: 15/959,941

(22) Filed: Apr. 23, 2018

(30) Foreign Application Priority Data
Jun. 20, 2017 (JP) 2017-120535

(51) Int. Cl. B60R 25/24; B60Q 1/50; B60R 25/01; B60R 25/31

(52) U.S. Cl. CPC B60R 25/245; B60R 25/31; B60R 25/01; B60Q 1/50

(57) ABSTRACT

The present invention is to provide a vehicle lighting system which can inform a predefined area outside a vehicle to a user. The microcomputer unlocks a door lock when the user approaches a drive area, and opens a sliding door. A lighting section illuminates the drive area of the ground and a movable area of the back door to inform the drive area and the movable area. The microcomputer causes the lighting section to illuminate the drive area and the movable area when detecting that there is a person around the stopped vehicle.

### BACKGROUND OF THE INVENTION

### Technical Field

The present invention relates to a vehicle lighting system.

### Related Art

Recently, there is a vehicle that a door lock mechanism or a door (load) is driven, and then a response such as automatically unlocking door lock, opening the door and so on are performed at a vehicle side when a user having a smart key approaches the vehicle. However, the user doesn't know an area where those responses are performed near the vehicle. For this reason, unexpected response (including a case not showing a response contrary to unexpected action. Hereafter, the same) sometimes occurs. For example, when the user has no mind to unlock door lock, the door lock is unexpectedly unlocked. Conversely, when the user want to unlock the door lock, the door lock is not unlocked. Furthermore, the user exists in area in which the user should avoid when the door is automatically opened.

### SUMMARY OF THE INVENTION

In view of the foregoing problem, the present invention aims to provide a vehicle lighting system which can control an unexpected response at a vehicle side.

The vehicle lighting system according to one embodiment of the present invention is a vehicle lighting system mounted on a vehicle. The vehicle lighting system includes a lighting section for illuminating a predefined area on a ground and informing the predefined area, a detection section detecting that there is a person in an approach area around the parked vehicle, and a control section causing the lighting section to illuminate the predefined area when the detection section detects that there is a person in the approach area.

Preferably, when the detection section detects that there is a mobile terminal in the approach area which is broader than the predefined area and includes the predefined area by wireless communication with the mobile terminal, the detection section determines that there is a person in the approach area.

Preferably, a first drive section driving a load when detecting that there is the mobile terminal in a drive area by wireless communication with the mobile terminal is mounted on the vehicle, and the predefined area is set to at least a part of the drive area.

Preferably, the load is a door lock mechanism, and the first drive section drives and unlocks the door lock mechanism when detecting that there is the mobile terminal in the drive area.

Further preferably, the load is a driving mechanism of a sliding door, and the first drive section drives and opens the sliding door when detecting that there is the mobile terminal in the drive area.

Preferably, a second drive section driving a movable section may be mounted on the vehicle, and the predefined area may be set to include a movable area of the movable section.

The movable section may be a back door, a rail for lifting, a platform, or stairs.

As explained above, according to the present invention, since it is possible to inform the predefined area outside the vehicle to the user, an unexpected response at a vehicle side can be controlled.

### BRIEF DESCRIPTION OF THE DRAWINGS

FIG. 1 is a block diagram showing one embodiment of a vehicle lighting system of the present invention;

FIG. 2 is a view for explaining an area illuminated by the vehicle lighting system shown in FIG. 1;

FIG. 3 is a view showing a lighting example of the vehicle lighting system shown in FIG. 1;

FIG. 4 is a view showing another lighting example of the vehicle lighting system shown in FIG. 1; and

FIG. 5 is a flowchart showing an operation of a microcomputer constructing the vehicle lighting system of FIG. 1.

### DESCRIPTION OF THE PREFERRED EMBODIMENT

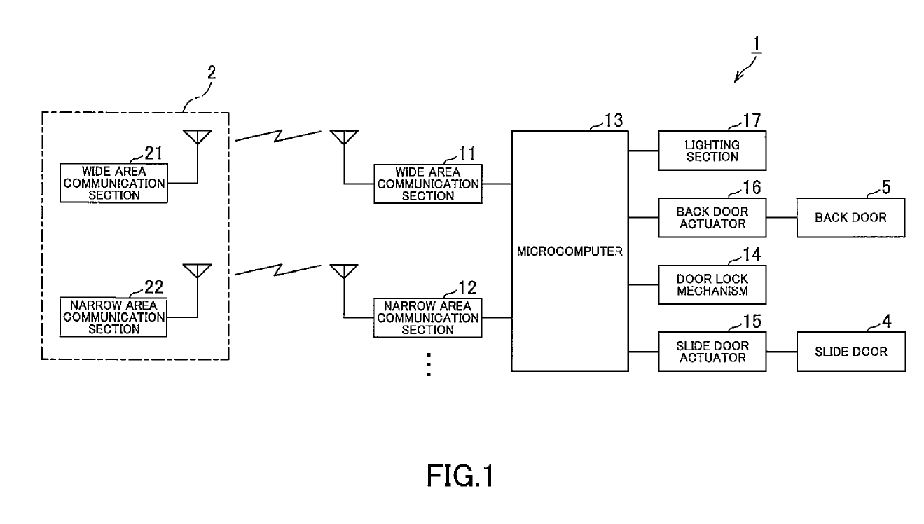

Hereafter, one embodiment of the present invention will be explained with reference to FIGS. 1 to 4. FIG. 1 is a block diagram showing one embodiment of a vehicle lighting system of the present invention. The vehicle lighting system 1 shown in FIG. 1 is mounted on a vehicle 3. As shown in FIG. 1, the vehicle lighting system 1 includes a wide area communication section 11, a plurality of narrow area communication sections 12, a microcomputer 13, a door lock mechanism 14, a slide door actuator 15, a back door actuator 16, and a lighting section 17.

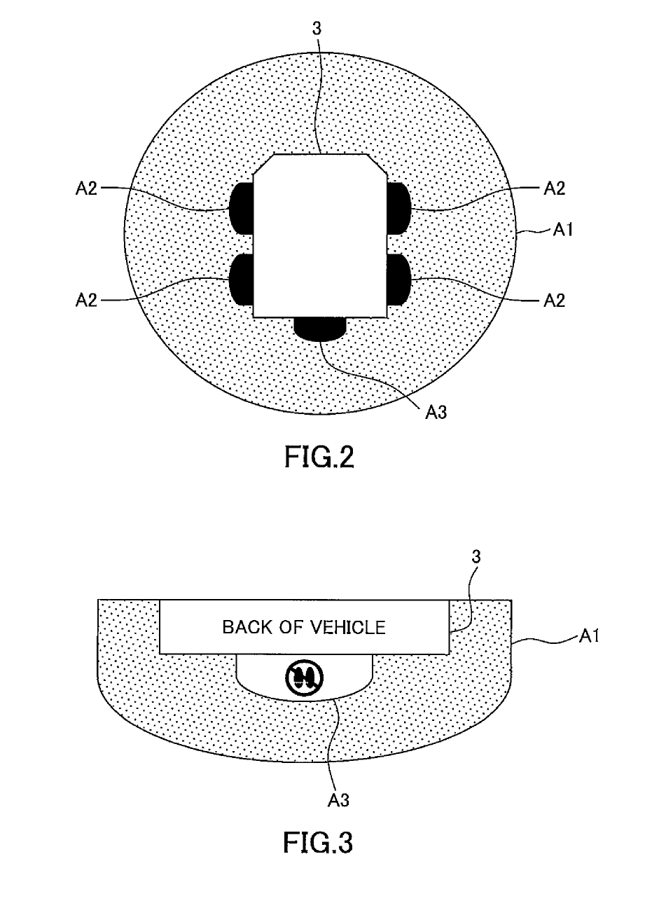

The wide area communication section 11 has a well-known communication equipment for performing wireless communication by using an antenna AT1, and performs wireless communication with a wide area communication section 21 in a smart key 2 as a mobile terminal which is be able to be carried by a user. As shown in FIG. 2, the wide area communication section 11 can communicate with the smart key 2 in a communication area (hereafter, approach area) A1 centering on the vehicle 3 including an area outside the vehicle 3. The approach area A1 is a wide area including a drive area A and a movable area A3 mentioned below.

The narrow area communication section 12 has a well-known communication equipment for performing wireless communication, and performs wireless communication with a narrow area communication section 22 in the smart key 2. The narrow area communication section 12 is arranged on each of four side doors. Further, as shown in FIG. 2, the narrow area communication section 12 can communicate with the smart key 2 in a narrow communication area (hereafter, drive area) A2 around the side door of the vehicle. The drive area A2 is narrower than the approach area A1, and included in the approach area A1.

Also, in the embodiment of the present invention, the narrow area communication sections 12 are arranged on all of the four side doors, but it is not limited thereto. Depending on the vehicle, the narrow area communication section 12 may be arranged on only the side door at the driver seat side, or it may be arranged on only the side doors at the driver seat side and at a passenger seat side.

The microcomputer 13 has a built-in CPU, a ROM, and a RAM and so on, and controls all of the vehicle lighting system.

The door lock mechanism 14 is a mechanism for locking/unlocking the door. The microcomputer 13 determines whether the smart key 2 is present in the drive area A2 or not by communicating between the smart key 2 and the narrow area communication section 12. When it is determined that the smart key 2 is present in the drive area A2, the microcomputer 13 is function as a first drive section, controls the door lock mechanism 14 as a load, and unlocks door lock.

The slide door actuator 15 drives the sliding door 4 arranged on the vehicle 3 at the rear side to open and close it. The microcomputer 13 determines whether the smart key 2 is present in the drive area A2 or not by communicating between the smart key 2 and the narrow area communication section 12. When it is determined that the smart key 2 is present in the drive area A2, the microcomputer 13 is function as a first drive section, controls the slide door actuator 15 as a load, and opens the sliding door 4.

The back door actuator 16 drives the back door 5 as a movable section to open and close it. When it is determined that open/close operation of the back door 5 is performed by a user, the microcomputer 13 is function as a second drive section, controls the back door actuator 16, and opens/closes the back door 5. The open/close operation of the back door 5 may be performed by using the smart key 2, or by using a switch arranged near the back door 5 of the vehicle.

The lighting section 17 irradiates (projects) visible light such as laser light on the ground outside the vehicle, and illuminates the predefined area. In the embodiment of the present invention, the above drive area A2 (=the predefined area) on the ground shown in FIG. 2 is set as the predefined area. Meanwhile, it is not necessary to match the predefined area to the drive area A2. The predefined area just has to be set to at least a part of the drive area A2. For example, the predefined area may be set to be slightly an area smaller than the drive area A2.

Further, in the embodiment of the present invention, the movable area A3 of the back door 5 on the ground in the vehicle 3 shown in FIG. 2 is set to the determined area. Meanwhile, it is not necessary to exactly match the determined area with the movable area A3. The predefined area may include the movable area A3. For example, the predefined area may be set to be slightly an area larger than the movable area A3.

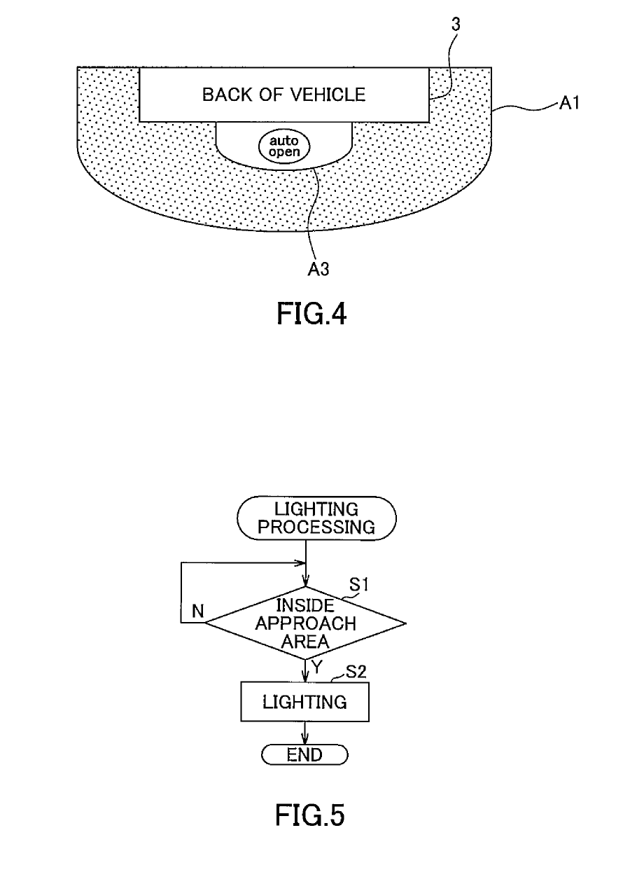

The lighting section 17 irradiates light having directivity such as laser light and high convergence, and illuminates the drive area A2 set as the predefined area, the movable area A3, and other area so as to distinguish them. Further, if a projector is used as the light section 17, it is possible to irradiate picture or character on the ground. Herein, as shown in FIG. 3, a mark for prohibiting entry shown in FIG. 3, a character such as “auto open” shown in FIG. 4 and so on can be projected in the movable area A3 so as to warn the user not to be entered in the movable area A3.

Next, an operation of the vehicle lighting system 1 having the above structure will be explained with reference to FIG. 5. For example, when the vehicle stops, the microcomputer 13 starts a lighting process of FIG. 5.

In lighting processing, the microcomputer 13 is function as a detection section, and detects that the user is in the vicinity of the vehicle 3 and enters the approach area A1 by communicating with the wide communication section 11 and the smart key 2 (step S1). When an entry is detected (Y in step S1), the microcomputer 13 is function as a control section, controls the lighting section 17, illuminates the drive area A2 and the movable area A3 (step S2), and ends the process. Furthermore, it is consider that the lighting is for example turned off at the timing when the ignition of the vehicle 3 is turned ON.

According to the embodiment of the present invention, the lighting section 17 illuminates the drive area A2 on the ground and the movable area A3 so as to inform the user of the drive area A2 and the movable area A3. When the microcomputer 13 detects that the user is present around the 1 parked vehicle 3 and enters in the approach area A1 by communicating with the smart key 2, the drive area A2 and the movable area A3 are illuminated by the lighting section 17.

Thereby, it is possible to inform the drive area A2 and the movable area A3 outside the vehicle to the user. Thus, an unexpected response at the vehicle side can be controlled. Further, by informing the user of the drive area A2, the user can understand an area where the door is locked when the user is present around the vehicle. In recent years, incident that a vehicle or valuables in the vehicle get stolen when the user is refueling has been reported. This is because the user is near the vehicle, the door lock is released. As mentioned above, by informing the drive area A2 to the user, the user can grasp lock and unlock of the door, and thereby it is also possible to prevent theft.

Further, by informing the drive area A2, the user can understand how far the sliding door opens as the user approaches the vehicle.

Furthermore, by informing the movable area A3, the user can understand an area that the user does not need to avoid the back door 5 which suddenly open and close.

Moreover, since the lighting section 17 illuminates visible light, it is possible to inform the drive area A2 and the movable area A3 even in the daytime.

According to the embodiment of the present invention, the microcomputer 13 detects that there is a person when the smart key 2 is present in the approach area A1 by wireless communication with the smart key 2. Thereby, it is possible to easily detect that there is a specific person having the smart key 2.

Also, according to the embodiment of the present invention, the movable area A3 of the back door 5 is illuminated by the lighting section 17, but it is not limited thereto. A standby area in which the user should stand outside the movable area A3 as set to the predefined area may be illuminated by the lighting section 17.

Further, according to the embodiment described above, the back door 5 as the movable section is explained as one example, but it is not limited thereto. For example, in the future, when an automatic driving taxi becomes popular, a function that the side door is automatically opened when detecting a passenger after stopping at the destination is likely to be mounted on the taxi vehicle. In this case, the side door is the movable section. When a passenger is detected, the movable area of the side door is illuminated and informed by the lighting section before opening the side door, and then the side door may be opened.

Furthermore, the movable section just has to an object mounted on the vehicle and movable. It may be a rail for lifting a wheelchair, a platform for moving up and down a luggage, a movable staircase (step) or the like.

In addition, according to the above embodiment, the vehicle lighting system 1 detects that a person is present near the vehicle 3 by communicating with the smart key 2, but it is not limited thereto. For example, by using an imaging unit such as a light sensor or camera, detection that a person is present around the vehicle may be performed.

Also, the present invention is not limited to the above embodiment. That is, those skilled in the art are capable of making various modifications according to conventional known knowledge without departing from the scope of the present invention.

### REFERENCE SINGS LIST

1 vehicle lighting system
2 smart key (mobile terminal)
3 vehicle
5 back door (movable section)
13 microcomputer (detection section, control section, first drive section, second drive section)
14 door lock mechanism (load)
17 lighting section
A1 approach area
A2 drive area (predefined area)
A3 movable area (predefined area)
A4 communication area (predefined area)

1. A vehicle lighting system mounted on a vehicle comprising:
a lighting section illuminating a predefined area on a ground and informing the predefined area;
a detection section detecting that there is a person in an approach area around the parked vehicle; and
a control section causing the lighting section to illuminate the predefined area when the detection section detects that there is the person in the approach area.

2. The vehicle lighting system according to claim 1, wherein when the detection section detects that there is a mobile terminal in the approach area which is broader than the predefined area and includes the predefined area by wireless communication with the mobile terminal, the detection section determines that there is the person in the approach area.

3. The vehicle lighting system according to claim 1, wherein a first drive section driving a load when detecting that there is the mobile terminal in a drive area by wireless communication with the mobile terminal is mounted on the vehicle, and
the predefined area is set to at least a part of the drive area.

4. The vehicle lighting system according to claim 2, wherein a first drive section driving a load when detecting that there is the mobile terminal in a drive area by wireless communication with the mobile terminal is mounted on the vehicle, and
the predefined area is set to at least a part of the drive area.

5. The vehicle lighting system according to claim 3, wherein the load is a door lock mechanism, and
the first drive section drives and unlocks the door lock mechanism when detecting that there is the mobile terminal in the drive area.

6. The vehicle lighting system according to claim 4, wherein the load is a door lock mechanism, and
the first drive section drives and unlocks the door lock mechanism when detecting that there is the mobile terminal in the drive area.

7. The vehicle lighting system according to claim 3, wherein the load is a driving mechanism of a sliding door, and
the first drive section drives and opens the sliding door when detecting that there is the mobile terminal in the drive area.

8. The vehicle lighting system according to claim 4, wherein the load is a driving mechanism of a sliding door, and
the first drive section drives and opens the sliding door when detecting that there is the mobile terminal in the drive area.

9. The vehicle lighting system according to claim 1, wherein a second drive section driving a movable section is mounted on the vehicle, and
the predefined area is set to include a movable area of the movable section.

10. The vehicle lighting system according to claim 2, wherein a second drive section driving a movable section is mounted on the vehicle, and
the predefined area is set to include a movable area of the movable section.

11. The vehicle lighting system according to claim 3, wherein a second drive section driving a movable section is mounted on the vehicle, and
the predefined area is set to include a movable area of the movable section.

12. The vehicle lighting system according to claim 4, wherein a second drive section driving a movable section is mounted on the vehicle, and
the predefined area is set to include a movable area of the movable section.

13. The vehicle lighting system according to claim 5, wherein a second drive section driving a movable section is mounted on the vehicle, and
the predefined area is set to include a movable area of the movable section.

14. The vehicle lighting system according to claim 6, wherein a second drive section driving a movable section is mounted on the vehicle, and
the predefined area is set to include a movable area of the movable section.

15. The vehicle lighting system according to claim 7, wherein a second drive section driving a movable section is mounted on the vehicle, and
the predefined area is set to include a movable area of the movable section.

16. The vehicle lighting system according to claim 8, wherein a second drive section driving a movable section is mounted on the vehicle, and
the predefined area is set to include a movable area of the movable section.

17. The vehicle lighting system according to claim 5, wherein the movable section is a back door, a rail for lifting, a platform, or stairs.

18. The vehicle lighting system according to claim 6, wherein the movable section is a back door, a rail for lifting, a platform, or stairs.
